(19) United States
(12) Patent Application Publication
(10) Pub. No.: US 2022/0369548 A1
(43) Pub. Date: Nov. 24, 2022

(54) A CUTTING LBADE AND A CUTTING ASSEMBLY

(71) Applicant: TRIMAX MOWING SYSTEMS NZ LIMITED, Hamilton (NZ)

(72) Inventors: Jason John CHEETHAM, HAMILTON (NZ); Jason Deans Cansfield LOW, HAMILTON (NZ); James Iain MCEWEN, HAMILTON (NZ); Thomas Allan ARCHBOLD, HAMILTON (NZ); Kieran Gerard O'MAHONY, HAMILTON (NZ)

(21) Appl. No.: 17/769,728

(22) PCT Filed: Oct. 19, 2020
(86) PCT No.: PCT/NZ2020/050129

§ 371 Date: Apr. 15, 2022

(30) Foreign Application Priority Data
Oct. 18, 2019 (NZ) 758364

(51) Int. Cl. A01D 34/73

(52) U.S. Cl. CPC A01D 34/736; A01D 34/733; A01D 2101/00

(57) ABSTRACT

This specification describes improvements to cutting blades and a cutting blade assembly. In some forms the cutting blade includes an upturn with an upturn radial angle which is non-parallel to a reference axis.

### FIELD OF INVENTION

The present invention relates to a cutting blade and a cutting assembly including the cutting blade the invention is suitable for, but not limited to, mowers designed to cut grass.

### BACKGROUND TO THE INVENTION

Mowers are machines used to cut plant matter such as grass. These mowers can take various forms and configurations from simple push mowers for personal/at-home use, to large tractor powered mowing attachments or autonomous mowers.

In general terms, a mower includes at least one cutting blade and a drive system which moves the blade(s) to cut the plant matter.

The performance of a cutting blade can be assessed against a range of criteria including clipping spread, clumping, brooming, noise and energy efficiency.

Clipping spread refers to the distribution of cut grass clippings over the ground. A better clipping spread reflects that the grass clippings are not concentrated but are uniformly distributed. Clumping refers to the clusters of compacted grass that group together and are discharged from the cutting chamber during mowing. A mower that reduces the occurrence of clumping is advantageous as it mitigates the damage caused when the clumps of grass smother the underlying vegetation.

Brooming refers to the cleanliness of cut. A mower and cutting blade that gives a cleaner cut is advantageous as it prevents shredding or tearing of the grass which can adversely affect its growth or the appearance of a mown lawn. A broomed cut refers to grass that has not been cut cleanly.

Energy efficiency is related to the power consumed to rotate the cutting blade during operation, the lower the better.

It is important for manufacturers of mowers and cutting blades to carefully design these products to optimise performance.

It is difficult because some of the criteria for cutting blade performance are subjectively assessed while others are objectively assessed. For instance, brooming and clipping spread are matters for personal assessment while energy efficiency and noise can be objectively determined. Therefore, appropriately assessing performance of one criterion, and the interaction of features on the various criteria, is complex.

In addition, a cutting blade, and cutting assembly including the cutting blade, should be easy and cost effective to manufacture. This is in order to facilitate mass reproduction, achieving economies of scale and to reduce costs.

A further challenge of cutting blades and cutting blade assemblies is that the component parts can be easily replaced due to wear and tear or damage. Ease of fabrication also reduces costs of replacement of parts of the assembly.

Some prior art mowers incorporate features which address some of the problems discussed above, although that is understood to be unintentional. Even if a blade provides an adequate solution to one of the prior art problems it may not adequately address other problems. There is therefore still a large unmet need for a cutting blade and cutting assembly which provides a better solution to user needs.

### OBJECT OF THE INVENTION

It is an object of the invention to provide a cutting blade, and a cutting assembly including the cutting blade, which has improved performance characteristics.

Alternatively, it is an object of the present invention to provide a cutting blade, and a cutting assembly including the cutting blade, having an improved clipping spread.

Alternatively, it is an object of the present invention to provide a cutting blade, and a cutting assembly including the cutting blade, that reduces brooming and thereby provides a relatively cleaner cut of grass.

Alternatively, it is an object of the present invention to provide a cutting blade, and a cutting assembly including the cutting blade, which reduces clumping.

Alternatively, it is an object of the present invention to provide a cutting blade, and a cutting assembly including the cutting blade, which is quieter in use.

Alternatively, it is an object of the present invention to provide a cutting blade, and a cutting assembly including the cutting blade, which improves energy efficiency in use.

Alternatively, it is an object of the present invention to provide a cutting blade, and a cutting assembly including the cutting blade, which is easy to manufacture

Alternatively, it is an object of the invention to at least provide the public with a useful choice.

### SUMMARY OF THE INVENTION

According to a first aspect of the invention, there is provided a cutting assembly, comprising at least one cutting blade, wherein the cutting blade includes a body having one or more cutting edges, and further wherein the body has an upturn.

According to another aspect of the invention, there is provided a cutting blade, wherein the cutting blade includes a body having one or more cutting edges, and further wherein the body has an upturn.

Throughout the present specification, reference to the term “cutting assembly” should be understood as meaning an assembly of components including at least one cutting blade that can in use cut plant material.

Throughout the present specification, reference to the term “cutting blade” should be understood as meaning an object having at least one cutting edge which in use cuts plant material.

In preferred embodiments, the cutting assembly is provided in, or forms part of, a mower such as a mower to cut grass. Accordingly, another aspect of the invention relates to a mower including a cutting assembly and cutting blade(s) according to another aspect of the invention.

In an embodiment, the cutting assembly may comprise a mounting beam.

Throughout the present specification, reference to the term “mounting beam” should be understood as meaning a structure or component to which at least one cutting blade may be mounted.

In a preferred embodiment, the mounting beam is permanently or releasably attached to a drive system to facilitate rotation of the mounting beam in use. However, it is also envisaged that the cutting blade(s) according to the present invention may be directly connected to a drive system.

In an embodiment, the cutting assembly may comprise a mounting beam and at least one cutting blade. The mounting beam in use rotates around a centre of rotation. A cutting blade is attached to an end of the mounting beam, and preferably a cutting blade is attached to each end of the mounting beam. The cutting blade(s) may be pivotably attached to the mounting beam or rigidly fixed thereto.

In an alternate embodiment, the cutting assembly may not have a separate mounting beam. Instead, the cutting blade may be shaped and/or dimensioned to facilitate connecting it to the drive system e.g. the cutting blade is a one-piece integral component or a solid blade.

In a preferred embodiment, the cutting blade may include an attachment point.

Throughout the present specification, reference to the term “attachment point” should be understood as meaning a point at which the at least one cutting blade is attached to the mounting beam.

The attachment point may be the point at which a component or structure to facilitate the cutting blade being attached to a mounting beam is provided. For instance, in some embodiments, the attachment point may be an aperture configured to receive a bolt, to thereby attach the cutting blade to the mounting beam. Alternatively, the attachment point may be any other component that can permanently or releasably attach the cutting blade to the mounting beam.

Throughout the present specification, reference to the term “upturn” should be understood as meaning a part of the cutting blade which extends upwards with respect to a plane in which the cutting edge rotates in use.

In a preferred embodiment, the upturn and the cutting edge are located on distal sides of the body of the cutting blade. In these embodiments, the cutting edge is formed in, or provided on, a forward edge of the cutting blade, while the upturn provides a rearward edge of the cutting blade.

Throughout the present specification, features of the cutting blade will be described by reference to certain relative terms. These terms, and the respective meanings, are:
“Forward” and “rearward” referring to the cutting assembly's direction of rotation in use; and
“Inner” and “outer” referring to the location of parts of a cutting blade or assembly which are assessed with respect to the centre of rotation of the cutting blade in use.

The features of the upturn can be described with respect to various parameters of the cutting blade, including:
An “upturn radial angle”;
An “upturn vertical angle”; and
An “upturn vertical height”.

The inventors have surprisingly found that these features may affect cutting blade performance. For instance, the upturn radial angle can improve the clipping spread and power consumption of a cutting blade, and consequently of the cutting assembly and of the mower. Similarly, having the upturn vertical angle and upturn height, particularly in range specified herein, can reduce power consumption in use. The upturn vertical height, particularly in the range specified herein, can significantly reduce clumping. The overall performance of the cutting blade assembly therefore depends on optimising at least one of the various parameters of the upturn.

There may also be a synergistic interaction between the features of the upturn and effects on the performance of the cutting blade. For instance, the clipping spread can be improved by having the upturn vertical angle in a specific range. Therefore, optimising the clipping spread can require careful selection of at least one of the upturn radial angle and the upturn vertical angle, in combination with the upturn vertical height.

The range of one parameter of the cutting blade may also interfere with the performance observed to arise from another parameter. For instance, the clipping spread of the cutting blade was observed to improve with increase in the magnitude of the upturn vertical angle within a certain range of upturn radial angles. However, increasing the upturn vertical angle leads increased power consumption and clumping. Therefore, the most optimal performance characteristics of the cutting blade cannot be achieved by modifying individual features of the upturn.

In addition, having an upturn radial angle, an upturn vertical angle and/or an upturn vertical height in an optimal range may also reduce noise of the cutting assembly in use and may improve manufacturability. The respective ranges of the upturn radial angle, the upturn vertical height and the upturn vertical angle, as defined by the present invention, balances and optimises the overall combination of the performance characteristics of the cutting blade.

These features should become clearer from the following discussion.

Throughout the present specification, reference to the term “upturn radial angle” should be understood as meaning an angle between an axis that extends along the forward-most edge of the upturn (referred to herein as the “upturn axis”) and a reference axis.

In an embodiment, the reference axis may be an axis that extends along a leading edge of a part of the cutting blade.

Throughout the present specification, reference to the term “leading edge” should be understood as meaning an edge of the cutting blade that is located on the forward side of a part of the cutting blade.

In some embodiments, each part of the cutting blade may have its own leading edge, meaning that the cutting blade as a whole has multiple leading edges. For instance, a cutting portion may have a leading edge (in which the cutting edge is formed), a step may have a leading edge, and another portion has a leading edge. The leading edges can be parallel or otherwise aligned with each other or inclined with respect to each other. This should become clearer from the following discussion.

In a preferred embodiment, the leading edge(s) may be substantially parallel to an attachment axis e.g. an axis that extends from the attachment point to the centre of rotation of the cutting assembly. However, the leading edge(s) may also be non-parallel with the attachment axis.

In the embodiments where the reference axis extends along the leading edge, the upturn radial angle can be defined as an angle between an axis that extends along the leading edge and the upturn axis. In these embodiments, the upturn radial angle may be in a range of substantially 0° to substantially 30°. In a preferred embodiment, the upturn radial angle is substantially 20°.

However, in another embodiment, the reference axis may be an upturn radius axis e.g. an axis that extends from the centre of rotation of the cutting blade in use to an outer tip of the rear edge of the upturn. In this embodiment, the upturn radial angle may be defined as the angle between the upturn radius axis and the upturn axis. In this embodiment, the upturn radial angle may be in the range of substantially −2° to substantially 20°.

In an alternative embodiment, the “upturn radius axis” extends from the centre of rotation to a point of intersection between an axis that extends along the rear edge of the upturn and an axis that extends along a base edge of the cutting blade. The base of the cutting edge is the outermost edge of the cutting blade which lies between the upturn and the cutting edge.

The magnitude of the upturn radius axis gives the upturn radius of the cutting assembly. The range of the upturn radial angle varies with the upturn radius. In the embodiment where the upturn radial angle is in the range of substantially −2° to substantially 20°, the upturn radius is substantially 590 mm. In a preferred embodiment, the upturn radial angle is substantially 11°.

These ranges for the upturn radial angle described herein may provide numerous advantages, including that it may improve clipping spread while providing a cutting blade that is easy to manufacture, reducing clumping and brooming, and promoting power efficiency for a mower using the cutting blade.

Throughout the present specification, reference to the term “upturn vertical angle” should be understood as meaning an angle between a surface on which the upturn lies and a substantially horizontal plane.

In an embodiment, the substantially horizontal plane may be a plane in which the cutting edges lies and move in use. However, it is also envisaged that the substantially horizontal plane could be another plane and therefore the foregoing should not be seen as limiting on the scope of the present invention.

In a particularly preferred embodiment, the upturn vertical angle may be in the range of substantially 31° to substantially 49°.

Throughout the present specification, reference to the term “upturn vertical height” should be understood as meaning the vertical height between the highest point on the upturn and a substantially horizontal plane on which the cutting edge lies.

In a preferred embodiment, the upturn vertical height may be in the range of substantially 14 mm to substantially 22 mm. In a preferred embodiment, the upturn vertical height is substantially 15 mm.

Throughout the present specification, reference to the term “rake angle” should be understood as meaning the angle between an axis that extends along the cutting edge and a rake angle reference axis.

In a preferred embodiment, the rake angle reference axis is an axis that extends along a leading edge of a part of a cutting blade. In a particularly preferred embodiment, the leading edge is substantially parallel to a rotation axis that extends from the attachment point to the centre of rotation of the cutting assembly. However, the leading edge may also be non-parallel with the rotation axis.

In the embodiment where the mounting beam is integrally formed with the cutting blade, the leading edge extends in a direction parallel to a longitudinal axis of the cutting blade. For instance, the longitudinal axis may extend from an end of the cutting edge to the centre of rotation.

In the embodiment where the rake angle reference axis lies along the leading edge, the rake angle is defined as an angle between the axis that extends along the cutting edge and the axis that extends along the leading edge.

In a particularly preferred embodiment, the rake angle may be in a range of substantially 4° to substantially 41°. In a particularly preferred embodiment, the rake angle is substantially 20°.

The inventors have surprisingly found that the rake angle may affect the brooming of the cutting blade.

In an alternate embodiment, the reference axis may be an axis that extends along a cutting radius axis.

Throughout the present specification, reference to the term “cutting radius axis” should be understood as meaning an axis that extends from the centre of rotation to the outer tip of the cutting edge.

In these embodiments, the rake angle may be in the range of substantially 0° to substantially 30°.

In an alternative embodiment, reference to the term “cutting radius axis” may refer to an axis that extends from the centre of rotation to a point of intersection between an axis that extends along the cutting edge and an axis that extends along a base edge of the cutting blade.

In preferred embodiments, the cutting blade(s) according to the present invention may include an upturn void.

Throughout the present specification, reference to the term “upturn void” should be understood as meaning an open region between the inner most edge of the upturn and part of the cutting blade inwards of the upturn.

In preferred embodiments, the upturn void may be substantially continuous, meaning an absence of material, between the inner most edge of the upturn and the portion of the cutting blade inwards of the cutting blade.

In other preferred embodiments, the cutting blade(s) according to the present invention may include an upturn web.

In preferred embodiments, the upturn web may be substantially continuous providing a solid surface between the upturn and the portion of the cutting blade inwards of the cutting blade.

However, it is also envisaged that the upturn web may be perforated or have a mesh construction, thereby being discontinuous. Accordingly, the discussion herein should not be seen as limiting on the scope of the present invention.

In a preferred embodiment, the upturn web may have a generally triangular shape. However, the upturn web may have other shapes without deviating from the scope of the present invention.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is a bottom view of a mower deck according to an embodiment of the present invention;

FIG. 2A is a perspective view of the cutting assembly according to an embodiment of the present invention;

FIG. 2B is an exploded view of FIG. 2A;

FIG. 3A is a perspective view of a cutting blade according to an embodiment of the present invention;

FIG. 3B is a top view of the cutting blade of FIG. 3A;

FIG. 3C is a bottom view of the cutting blade of FIG. 3A;

FIG. 4 is a view of a cutting blade through line A-A shown in FIG. 3B;

FIG. 5 is a further top view of the cutting blade of FIG. 3A;

FIG. 6A is a further top view of the cutting blade of FIG. 3A showing additional features of a cutting blade according to an embodiment of the present invention;

FIG. 6B is a further top view of the cutting blade of FIG. 3A showing additional features of a cutting blade according to an embodiment of the present invention;

FIG. 7A is a top view of a cutting blade according to an embodiment of the present invention;

FIG. 7B is a perspective view of the cutting blade of FIG. 7A;

FIG. 7C is a bottom view of the cutting blade of FIG. 7A;

FIG. 7D is a further view of FIG. 7A showing additional features of a cutting blade according to an embodiment of the present invention;

FIG. 7E is a further view of FIG. 7A showing additional features of a cutting blade according to an embodiment of the present invention;

FIG. 8A is a top view of a cutting blade according to another aspect of the present invention;

FIG. 8B is a perspective view of the cutting blade of FIG. 8A;

FIG. 9A is a top view of a cutting blade according to a second embodiment of the present invention;

FIG. 9B is a perspective view of the cutting blade of FIG. 9A;

FIG. 10A is a top view of a cutting blade according to a third embodiment of the present invention.

### DESCRIPTION OF PREFERRED EMBODIMENTS OF THE INVENTION

Cutting Assembly

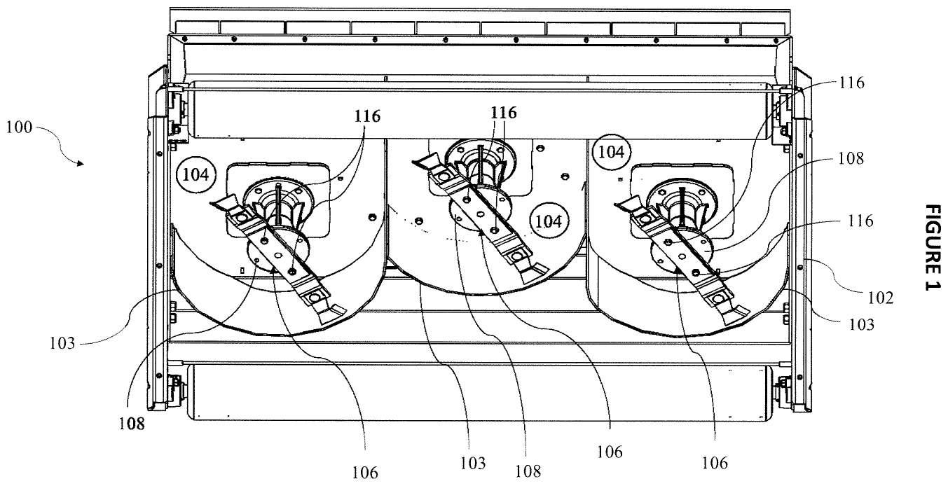

Referring first to FIG. 1, showing a bottom view of a mower deck (100) which is indicated as (100). The mower deck (100) comprises a housing (102) and at least one baffle (103) that together form at least one cutting chamber (indicated as (104)). At least one cutting assembly (106) is mounted in the cutting chamber(s) (104).

In the embodiment of FIG. 1, the mower deck (100) includes three housings (102) and three cutting assemblies (106). However, the mower deck (100) may have any required number of cutting assemblies (106).

The cutting assemblies (106) shown in FIG. 1 are fling-tip cutting assemblies as are discussed in more detail below.

Each cutting assembly (106) is mounted to a rotor (108) which is in turn mounted to a drive system (not shown in the Figures). In use, the drive system (not shown) can rotate the rotor(s) (108) which in turn rotate the respective cutting assembly (106) to facilitate the mower deck (100) cutting grass. However, each cutting assembly (106) may be a blade (200) as is discussed below.

The housing (102) includes a support frame (not shown) in FIG. 1 which facilitates attaching the mower deck (100) to a prime mover such as a tractor (not shown in FIG. 1). Alternatively, the mower deck (100) may be provided in an autonomous mower (not shown in the Figures).

In the embodiment of FIG. 1 the mower deck (100) is provided as a single-deck mower. However, the mower deck (100) may also be part of a multi-deck mower having two or mower decks, each of which are equivalent to the mower deck (100).

Fling-Tip Cutting Assembly

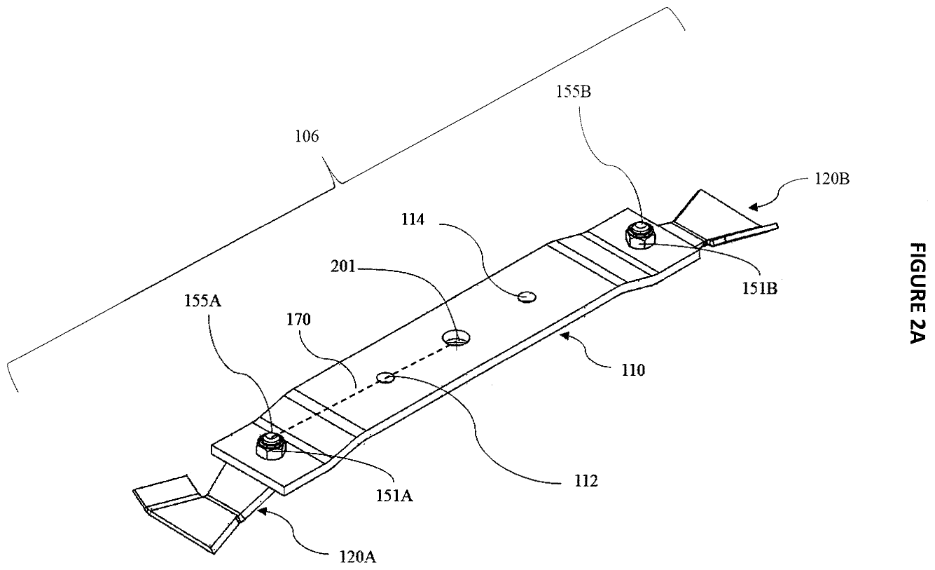

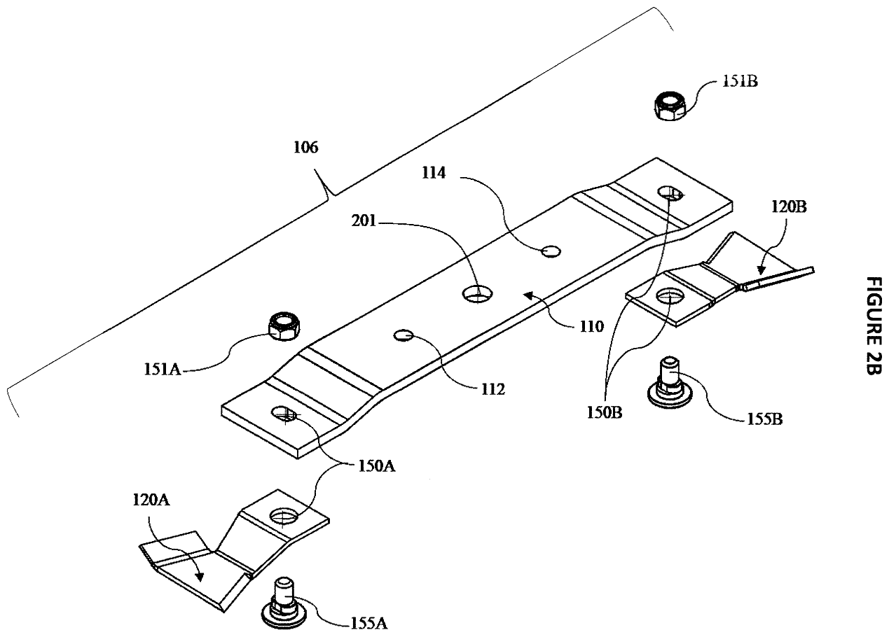

Referring now to FIG. 2A which shows the cutting assembly (106) according to an aspect of the invention, and FIG. 2B which is an exploded view of FIG. 2A. The cutting assembly (106) is a fling-tip type cutting assembly having a mounting beam (110) and at least one cutting blade (120A), and preferably a second cutting blade (120B).

The cutting blades (120A, 120B) are attached to the mounting beam (110) using a fastener arrangement e.g. removably. In the illustrated embodiments, the fastener arrangement is a nut (151A, 151B) and bolt (155A, 155B) which extend through corresponding apertures (150A, 150B) in the mounting beam and apertures (136A, 136B) in the cutting blades (120A, 120B). The apertures (150A, 150B) provide attachments points at which the cutting blades (120A, 120B) are attached to the mounting beam (110).

Removable attachment of the cutting blades (120A, 120B) to the mounting beam (110) reduce the cost of part replacement and serviceability and improves ease of manufacturing.

However, other fastener arrangements are envisaged including, but not limited to, clamping, clipping or magnetic methods. It is also envisaged that the cutting blades are permanently attached to the mounting beam (110) such as by welding, or that they can be formed integrally to the mounting beam as is discussed in more detail below with reference to FIGS. 2A and 2B.

In the illustrated embodiment, the fastener arrangement allows the cutting blades (120A, 120B) to pivot freely or partially with respect to the mounting beam (110). Alternatively, the fastener arrangement may fixedly attach the cutting blades (120A, 120B) to the mounting beam (110) to substantially prevent rotation of the cutting blades (120A, 120B) with respect to the mounting beam (110).

The mounting beam (110) includes an aperture (112), and preferably a second aperture (114). The aperture(s) (112, 114) facilitate connecting the mounting beam (110) to the rotor (108). The attachment of the mounting beam (110) to the rotor (108) is achieved by at least one bolt (116) (as shown in FIG. 1) which extends through one of the apertures (112, 114) and into a corresponding aperture (not shown in the Figures) in the rotor (108). The advantage of having multiple points (112, 114) of connection between the mounting beam (110) and the rotor (108) is that it may assist in locking the mounting beam with respect to the rotor (108), which can be beneficial for performance of the mower deck (100).

The mounting beam (110) includes a centre aperture (indicated as 201) located at substantially the mid-point along the length of the mounting beam (110). The centre aperture (201) provides an alignment feature to assist in positioning the mounting beam (110) with respect to the rotor (108). For instance, the centre aperture (201) can receive a corresponding boss (not shown) or other alignment feature on the rotor (108).

The apertures (112, 114) are located substantially symmetrically on either side of the centre aperture (201). The centre aperture (201) is also the centre of rotation for the mounting beam (110), and therefore also the cutting blades (120A, 120B) when attached thereto.

It is also envisaged that only one cutting blade e.g. (120A) could be attached to the mounting beam (110). Alternatively, the mounting beam (110) may adopt any shape having any number of arms and cutting blades attached to the arms. For instance, it is envisaged that the mounting beam (110) may have three arms and three cutting blades could be attached thereto, one to each arm. In yet a further alternative embodiment, the mounting beam may have four arms and cutting blade is attached to each of the arms i.e. the cutting assembly has four cutting blades.

### First Embodiment of a Cutting Blade

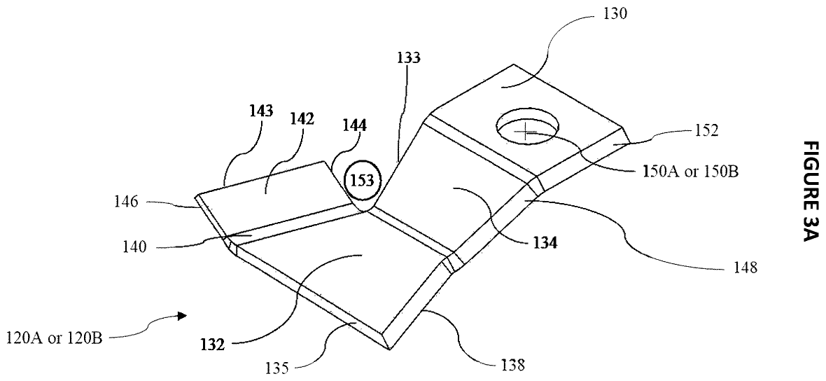

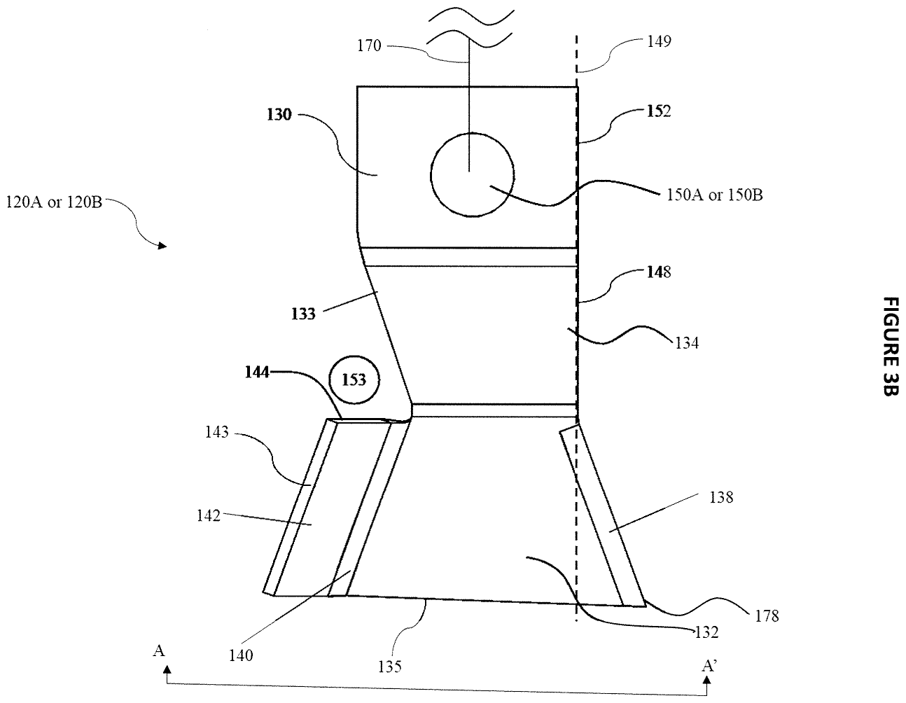

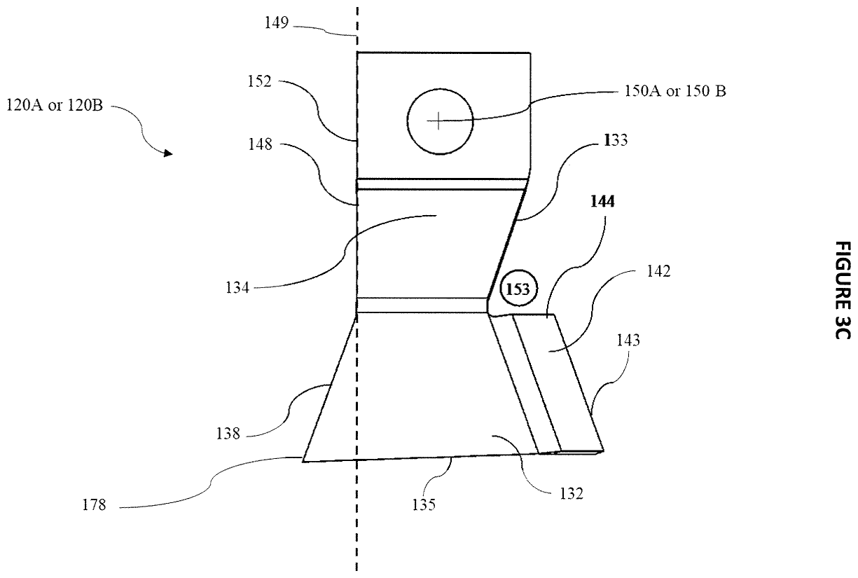

Referring now to FIG. 2B, together with FIGS. 3A, 3B and 3C which show additional views of the cutting blade (120A or 120B) illustrated in FIGS. 2A and 2B. As the cutting blades (120A, 120B) are identical to each other, only cutting blade (120A) will be described in detail.

The cutting blade (120A) includes a first portion (130) and a cutting portion (132) which are separated by a step (134). The aperture (136A) is provided in the first portion (130) and as discussed above facilitates attaching the cutting blade (120A) to the mounting beam (110).

When the cutting blade (120A) is rotationally aligned with the mounting beam (110) as shown in FIG. 2A, the cutting portion (132) is located farther away from the centre aperture (201) than the first portion (130). This provides the maximum possible moment arm for the cutting assembly (106) and may assist in reducing energy consumed to cut plant material.

The following discussion describes features of the cutting blade (120A) and cutting assembly (106) when assembled and with the cutting blade in the rotation orientation shown in FIG. 2A (amongst others). This will be referred to as “the reference position”. In the reference position, the longitudinal axis of the mounting beam (110) is substantially parallel to and colinear with, the longitudinal axis of the cutting blade (120A). It should be understood that in use the orientation of the cutting blade (120A) with respect to the mounting beam (110) may change according to various factors such as the weight of the cutting blade (120A), the amount of rotation of the cutting blade (120A) allowed by the fastener arrangement or other structure of the cutting assembly (106).

The cutting portion (132) includes a cutting edge (138) formed in a forward edge of the cutting portion (132). The cutting portion (132) lies on a substantially horizontal plane in use (not shown in the Figures) and has a rear edge (140) which is the edge of the cutting portion (132) distal from the cutting edge (138).

The cutting blade (120A) includes an upturn (142). The upturn (142) is orientated at an angle to the substantially horizontal plane (not shown) in which the cutting portion (132) lies and extends rearward of the rear edge (140) of the cutting portion (132). The rear edge (140) therefore provides a forward-most edge of the upturn (142).

The upturn (142) has a rear edge (143), an inner edge (144) and an outer edge (146).

The step (134) is orientated at an angle to a substantially horizontal plane (not marked in the Figures) in which the first portion (130) lies. Therefore, the first portion (130) is higher above the ground in use than the cutting portion (132). As a result, the cutting edge (138) is lower than the first portion (130) when the cutting assembly (106) is assembled and in use.

The arrangement and configuration of the step allows for a length of the cutting edge (138) that matches the travel speed of the prime mover, such that it decreases or eliminates the amount of uncut material remains after each pass of the mower.

Another advantage of the first portion (130) being higher above the ground than the cutting portion (132) is that there is a clearance between parts of the cutting assembly (106) and the ground. This ensures that components like bolts (116, 155A, 155B) or nuts (151A, 151B) that could project beyond the surface of the mounting beam (110) and the first portion (130) are less likely to come in contact with the ground when the mower deck (100) is in use.

The step (134) generally has a trapezoidal-shape which is defined by a leading edge (148) and a rearward edge (133) of the step (134). This is perhaps best seen in FIG. 3B. This shape may be particularly advantageous as it facilitates the other components having geometries required to provide the advantages of the present invention. However, other shapes for the step (134) are envisaged including a rectangle or parallelogram.

The first portion (130) has a leading edge (152). In the illustrated embodiment, the leading edges (148, 152) are substantially parallel to, and preferably substantially collinear to, each other when viewed from above. As illustrated in FIGS. 3B and 3C, the leading edges (148, 152) are parallel to an axis (149) when viewed from above.

In the embodiment shown in FIGS. 3A, 3B and 3C, the leading edges (148, 152) are substantially straight. In other embodiments, one or more of the leading edges (148, 152) may be curved.

The cutting blade (120A) includes a base edge (135) which is the outermost edge of the cutting blade (120A). In the embodiment illustrated in FIGS. 3A, 3B and 3C the base edge (135) is substantially straight. In other embodiments, the base edge (135) may have a curved shape.

The cutting blade (120A) has an upturn void (indicated by 153 in the Figures). The upturn void (153) is an area defined by the inner edge (144) of the upturn (142) and the rearward edge (133) of the step (134) that does not have any material i.e. it is “open”. An open void can reduce power consumption in use.

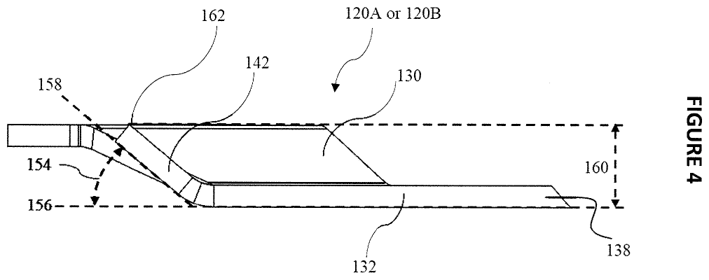

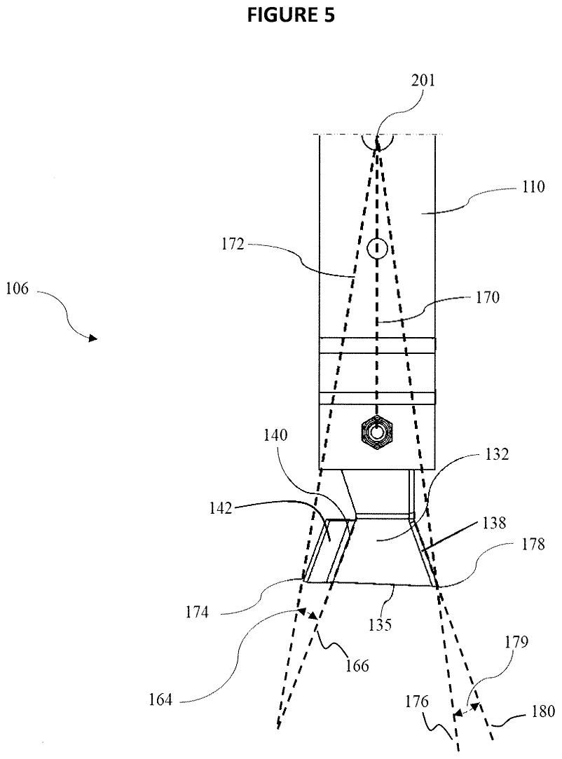

Referring now to FIGS. 4 and 5 which show additional aspects of the cutting blade (120A) and cutting assembly (106) according to the present invention.

FIG. 4 depicts the cutting blade (120A) perpendicularly from the plane A-A′ which may be seen in FIG. 3B.

The orientation and dimensions of the upturn (142) can be described with reference to an upturn vertical angle (154), an upturn radial angle (164) and an upturn vertical height (160).

In the embodiment illustrated in FIG. 4, the upturn vertical angle (154) is defined as the angle between a substantially horizontal plane (156) in which the cutting edge (138) lies and a plane (158) on which the upturn (142) lies.

In the embodiment of FIGS. 4 and 5, the upturn vertical angle (154) is preferably in a range of substantially 31° to substantially 49°, and is preferably substantially 40°.

The orientation of the upturn (142) may have an effect on the clipping spread and power consumption. The inventors have surprisingly found that the upturn radial angle (164), the upturn vertical angle (154), and the upturn vertical height (160) as described herein provide a desirable clipping spread while also optimising power consumption and having an acceptable level of clumping.

It is possible that a greater clipping spread may be obtained at other values for at least one of the upturn vertical angle (154), the upturn radial angle (164), and the upturn vertical height (160). However, the inventors have surprisingly found that other performance characteristics of the cutting blade (120A) and cutting assembly (106) deteriorate severely and below acceptable standards when values for at least one of the upturn vertical angle (154), the upturn radial angle (164), and the upturn vertical height (160) are outside of the ranges described herein. Accordingly, the invention balances competing factors which can affect performance of the cutting blade (120A) and cutting assembly (106).

For instance, clipping spread of the cutting blade (120A) and cutting assembly (106) can be evaluated by assessing mean residual spread, the lower the better. The inventors have found that for a specific range of upturn radial angles, the mean residual spread decreases as the magnitude of the upturn vertical angle (154) increases. However, the power consumption and clumping also increase as the magnitude of the upturn vertical angle (154) increases. The clipping spread may be improved only up to an upturn vertical angle (154) of substantially 49° before power consumption and clumping exceed acceptable limits. In addition, the magnitude of the upturn vertical angle (154) can be decreased to substantially 31° before clipping spreads falls below an acceptable level. Hence, having an upturn vertical angle (154) within the range of substantially 31° to substantially 49° provides an acceptable standard of clipping spread while also balancing other features for performance of the cutting blade (120A) and cutting assembly (106). In particularly preferred embodiments the upturn vertical angle is substantially 40°.

In addition, clipping spread and other performance characteristics depend not only on the upturn vertical angle, but a combination of all the geometric features of the cutting blade (120A).

The inventors have found that the upturn height (142) may be an important feature for the performance of the cutting blade (120A). In the embodiment of FIGS. 4 and 5, the upturn vertical height (160) is defined as the height of the upper most point (162) of the upturn (142) above a substantially horizontal plane in which the cutting edge (138) lies.

The inventors have found that the upturn height (142) may be an important feature for the performance of the cutting blade (120A). In the embodiment of FIGS. 4 and 5, the upturn vertical height (160) is defined as the height of the upper most point (162) of the upturn (142) above a substantially horizontal plane in which the cutting edge (138) lies.

In the embodiment of FIGS. 4 and 5, the upturn vertical height (160) is in the range of substantially 14 mm to substantially 22 mm, and preferably is substantially 15 mm. This range of heights may provide a desirable level of clipping spread while ensuring that blade design does not result in excess power consumption. This range also provides a reduction in clumping without exceeding acceptable limits in clipping spread.

The upturn radial angle (164) is defined with respect to a reference axis, e.g. an upturn radius axis (172) as illustrated in FIG. 5.

As can be seen in FIG. 5, the upturn radius axis (172) extends from an outer tip (174) of the upturn (142) to the centre aperture (201) i.e. the centre of rotation of the cutting assembly (106). In this embodiment, the upturn radial angle (164) is the angle between the upturn radius axis (172) and an upturn axis (166) which extends along the rear edge (140).

In the embodiment of FIG. 5, the upturn radial angle (164) is in the range of substantially −2° to substantially 20°, and preferably is substantially 11°.

In another embodiment (not shown in FIGS. 4 and 5), the outer edge of the upturn may be chamfered or rounded. In this embodiment, the upturn radius axis (172) extends from a virtual point (not indicated in the Figures) to the centre aperture (201). The virtual point may be located at the point of intersection between an axis that extends along the upturn rear edge (143) and an axis that extends from the base edge (135) which is the outermost edge of the cutting blade (120A).

The inventors have also surprisingly found that the orientation of the cutting edge (138) with respect to the other parts of the cutting blade (120A) i.e. the rake angle (179), can have an important effect on performance.

In FIG. 5, the rake angle (179) is defined as the angle between a cutting radius axis (176) that extends from the centre of rotation (201) to an outer edge (178) of the cutting edge (138) and an axis (180) which extends along the cutting edge (138).

In the embodiment of FIG. 5, the rake angle (179) is in the range of substantially 0° to substantially 30°, and preferably is substantially 12° The inventors have surprisingly found that having a rake angle in this range provides a cut which has a satisfactory level brooming. Increasing the rake angle above substantially 30° results in ineffective cutting with increased brooming (or an increase in uncut grass) exceeding acceptable levels. Having a rake angle of less than substantially 0° provides a less clean cut e.g. undesirable levels of brooming. As a result, the range of substantially 0° to 30° provides a balance for cut cleanliness and efficiency.

Alternative Description of a Cutting Blade

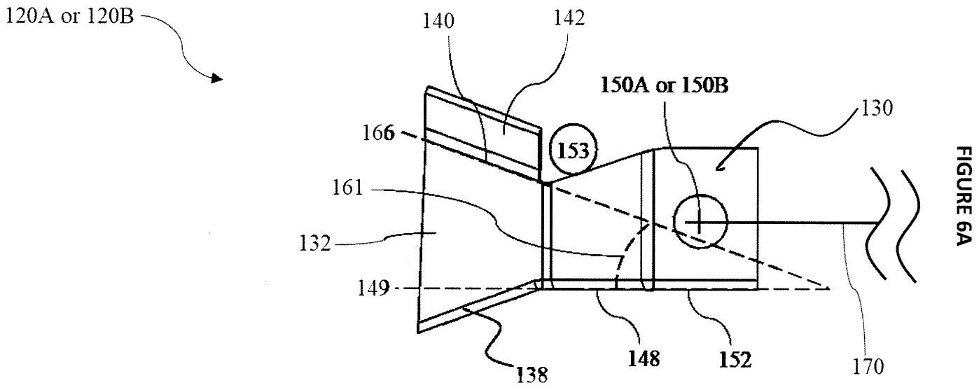

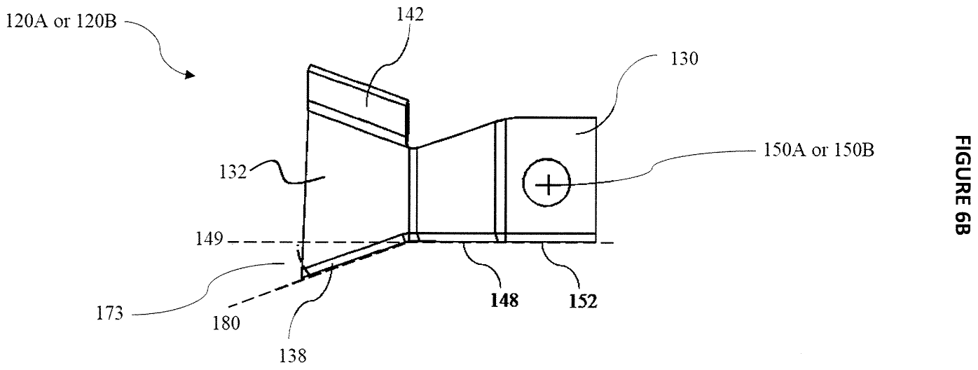

Referring now to FIGS. 6A and 6B which show further aspects of the cutting assembly (106) and cutting blade (120A or 120B) described above. Like numerals refer to like components.

In the embodiment of FIG. 6A, the upturn radial angle (161) is defined as an angle between the upturn axis (166) that extends along the rear edge (140) and an axis (149) that extends along the leading edge(s) (148 and/or 152). In this embodiment, the upturn radial angle is in a range of substantially 0° to substantially 30°, and preferably is substantially 20°.

It can be seen in FIG. 6A that the upturn axis (166) and therefore the rear edge (140) is orientated to define a taper in the cutting portion (132) in the direction of the step (134). Therefore, the cutting portion (132) has a generally trapezoidal-shape.

In the embodiment illustrated in FIG. 6A, the leading edge(s) (148, 152) is/are parallel to an axis (170) which extends from the centre aperture (201) to the attachment point (250). The axis (170) is best seen in FIG. 2A. Therefore, it should also be understood that the upturn radial angle (161) can also be described as an angle between the upturn axis (166) and the axis (170).

The orientation of the cutting edge (138) can be described by a rake angle (173). In the embodiment of FIGS. 6A and 6B, the rake angle (173) may be defined as the angle of the axis (180) that extends along the cutting edge (138) measured with respect to the axis (149) on which at least one of the leading edges (148, 152) lies.

In the embodiment of FIGS. 6A and 6B, the rake angle (173) is preferably in the range of substantially 4° to substantially 41°, and preferably is substantially 20°.

The advantages of having the upturn radial angle (161) and the rake angle (173) in the specified ranges in this alternative embodiment of the cutting blade (120A or 120B) are respectively the same as the advantages of the range of rake angles for the cutting blade (120A) described with reference to FIGS. 4 and 5 above.

One-Piece Cutting Assembly

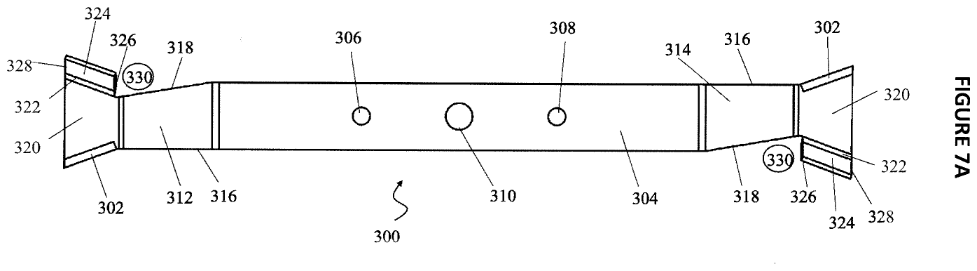

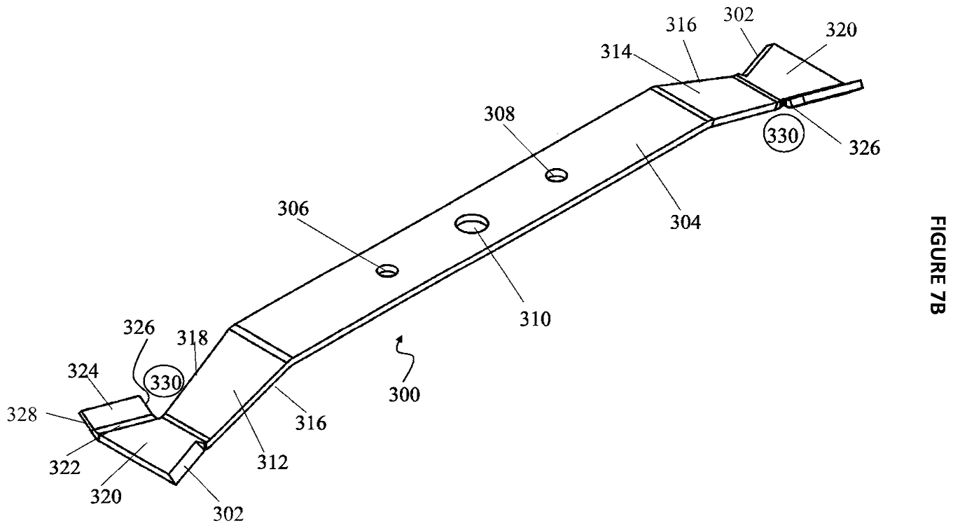

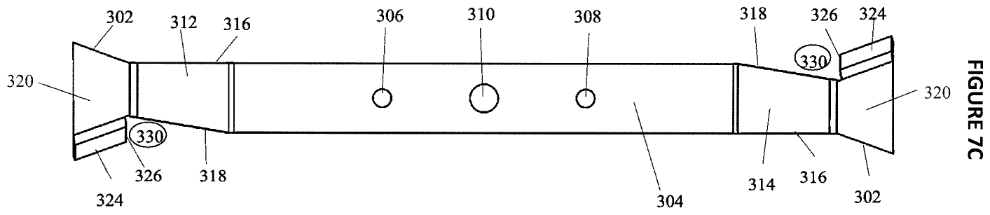

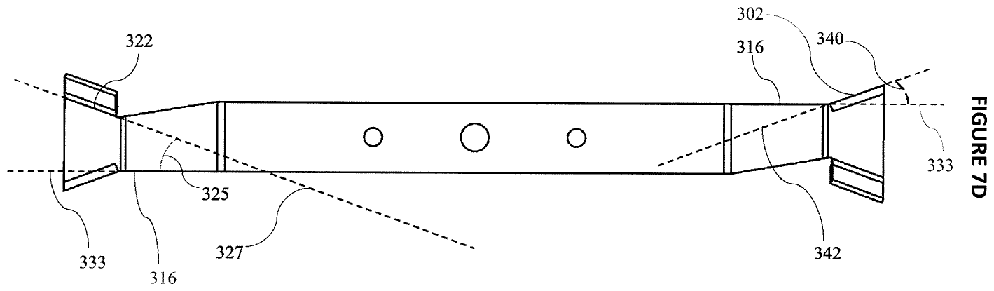

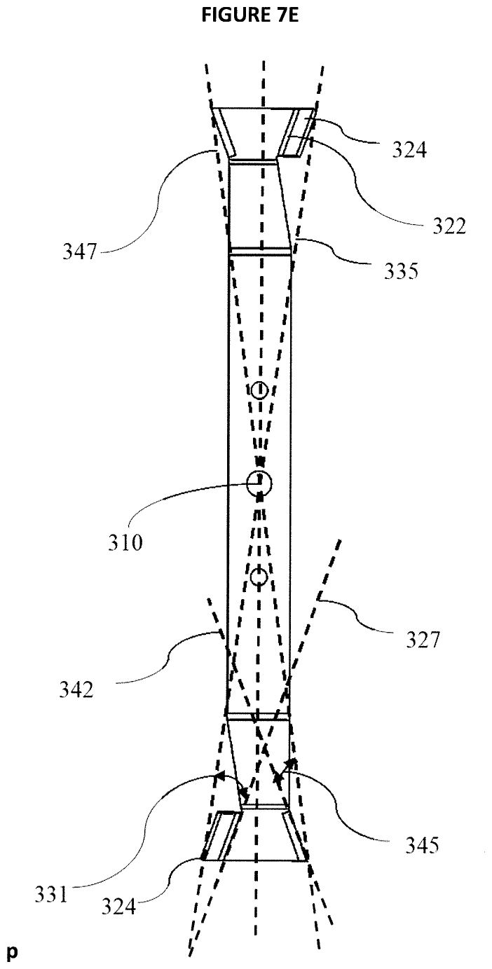

Referring now to FIGS. 7A, 7B, 7C, 7D and 7E which show another embodiment of a cutting blade (300) according to an aspect of the invention. In this embodiment the cutting blade (300) is formed as a one-piece component in which cutting edges (302) and mounting beam (304) are formed from the same piece of material as each other. The advantage of a one-piece cutting assembly is reduction in cost of manufacturing.

In an alternate embodiment (not shown in FIGS. 7A, 7B, 7C, 7D and 7E), the mounting beam (304) could be formed with only a single cutting edge (302) located at one end of the mounting beam (304). In yet a further alternate embodiment (not shown in FIGS. 7A, 7B, 7C, 7D and 7E), the mounting beam (304) may have a shape generally described as a three-pointed star having three arms, with a cutting edge (302) formed in each of the arms. In yet a further embodiment (not shown in FIGS. 7A, 7B, 7C, 7D and 7E), the mounting beam (304) may have four arms having one cutting blade attached to each arm.

The cutting blade (300) includes apertures (306, 308) that are located symmetrically on either side of the centre (310) of the cutting blade (300). The apertures (306, 308) facilitate attaching the cutting blade (300) to the rotor (108) as illustrated in FIG. 1 and thereby providing a cutting assembly according to an aspect of the present invention.

The centre (310) is located at the centre of rotation of the cutting blade (300) in use and the cutting blade (300) is symmetrical about the centre (310).

The cutting blade (300) includes a first step (312) and a second step (314) that are located at distal ends of the mounting beam (304) to each other. The steps (312, 314) are orientated at an incline to a substantially horizontal plane in which the mounting beam (304) lies in use, and therefore the cutting edges (302) are located lower than the mounting beam (304).

The steps (312, 314) each have a generally trapezoidal shape and a leading edge (316) and a rear edge (318) as is best seen in FIG. 7A.

The steps (312, 314) join the mounting beam (304) to cutting portions (320). The cutting edges (302) are formed in the respective forward edges of the cutting portions (320).

Each cutting portion (320) includes a rear edge (322) which is the is the edge of the cutting portions (320) distal from the cutting edges (302). The cutting edges (302) and the rear edges (322) each lie in a substantially horizontal plane in use.

An upturn (324) extends away from the rear edges (322) so that the rear edges (322) provide a forward edge for the upturns (324).

Each upturn (324) includes an inner edge (326) and an outer edge (328).

The upturns (324) are orientated at an angle to a substantially horizontal plane (not marked in the Figures) in which the cutting edges (302) lie. The orientation of the upturn (324) with respect to the substantially horizontal plane can be described by an upturn vertical angle (not shown in FIGS. 7A, 7B, 7C, 7D and 7E). The upturn vertical angle of each upturn (324) is identical to the upturn vertical angle (154) of the cutting blade (120A) as illustrated in FIG. 4. In the embodiment of FIGS. 7A, 7B, 7C, 7D and 7E, the upturn vertical angle (not marked) may be in the range of substantially 31° to substantially 49°, and preferably is substantially 40°.

The height of the upturns (324) above the substantially horizontal plane in which the cutting edges (302) lie can be referred to as an upturn vertical height (not marked in the FIGS. 7A, 7B, 7C, 7D and 7E). The upturn vertical height of each upturn (324) of the one-piece cutting blade (300) is identical to the upturn vertical height (160) of the cutting blade (120A) as illustrated in FIG. 4. In the embodiment of FIGS. 7A, 7B, 7C, 7D and 7E, the upturn vertical height is in the range of substantially 14 mm to substantially 22 mm, and preferably is substantially 15 mm.

In addition to the upturn vertical angle and the upturn vertical height, the orientation of the upturns (324) with respect to the cutting portions (320) can be described by reference to an upturn radial angle (325). In the description of FIGS. 7A, 7B, 7C and particularly 7D, the upturn radial angle (325) is defined as an angle between an axis (327) that extends along a rear edge (322) and an axis (333) that extends along the leading edge(s) (316). In the embodiment of FIGS. 7A, 7B, 7C and 7D, the upturn radial angle (325) may be in the range of substantially 0° to substantially 30°.

Alternatively, as shown in the description of FIGS. 7A, 7B, 7C and particularly 7E, the upturn radial angle (331) may also be defined as an angle between an axis (335) that extends from the centre (310) to an outer tip of each of the upturns (324) and the axis (327) that extends along the rear edge (322). The range of the upturn radial angle (331) in this alternative description is substantially −2° to substantially 20°, and preferably is substantially 11°.

As can be seen in FIGS. 7A, 7B, 7C, 7D and 7E, the cutting blade (300) includes at least one, and preferably two, upturn voids which are indicated generally by (330). The upturn voids (330) are a region bounded at least partially by the inner edge (326) of the upturn (324) and the rear edge (318) of each of the steps (312, 314). The upturn voids (330) generally have a triangular shape and are unbounded on one side.

The orientation of the cutting edge (302) with respect to the cutting portion (320) is defined by a rake angle (340). In a first description of the rake angle (340), illustrated particularly in FIG. 7D, it is defined as an angle between the axis (333) that extends along the leading edge(s) (316) and an axis (342) that lies along the cutting edge (302). The range of the rake angle (340), according to this description, illustrated by FIG. 7D, is substantially 4° to substantially 41°, and preferably is substantially 20°.

Alternatively, the rake angle (345) may also be defined as an angle between an axis (347) that extends from the centre (310) to an outer edge of the cutting edge (302) and the axis (342) that lies along the cutting edge (302). The range of the rake angle (345), according to this alternate description, illustrated by FIG. 7E, is substantially 0° to substantially 30°, and preferably is substantially 12°.

### Alternate Embodiment of a Cutting Blade

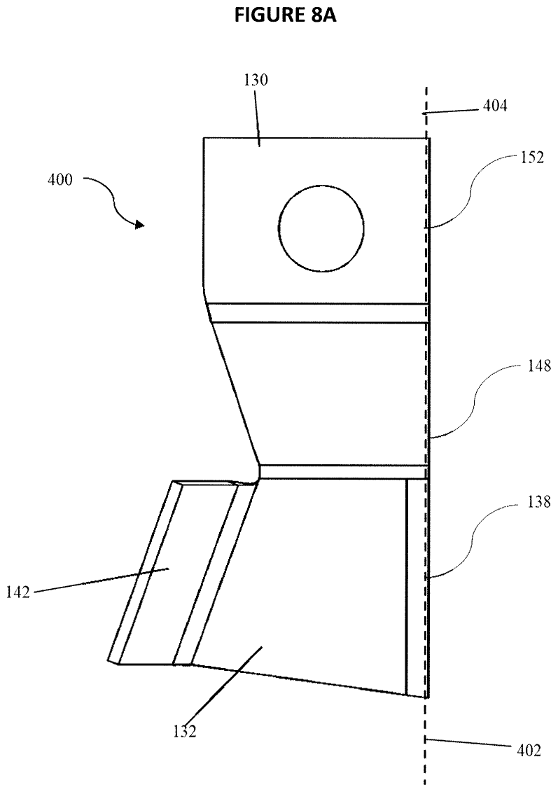

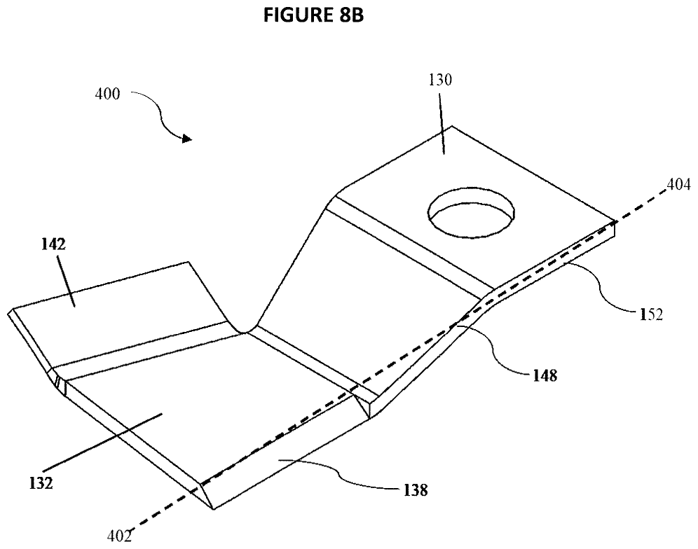

Referring now to FIGS. 8A and 8B which show an alternate embodiment of a cutting blade (400) according to an aspect of the present invention. The cutting blade (400) has some similarities to the cutting blade (120A, 120B) and therefore like numerals are used to refer to like features.

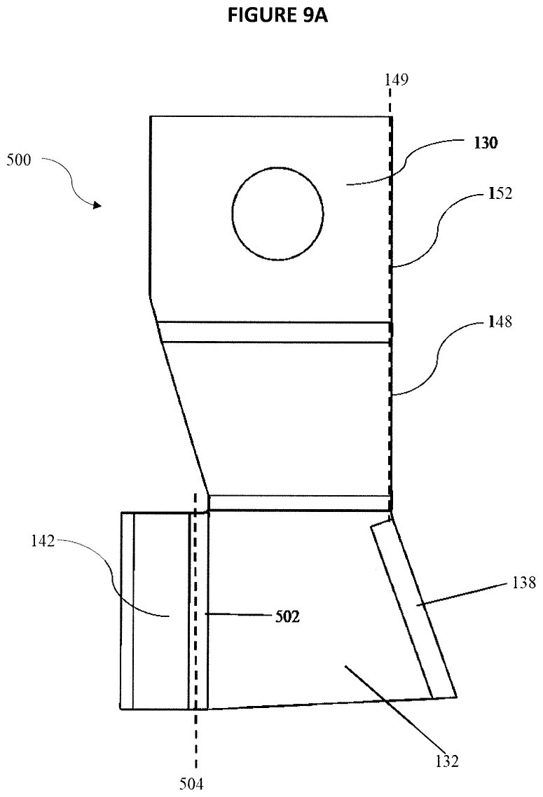

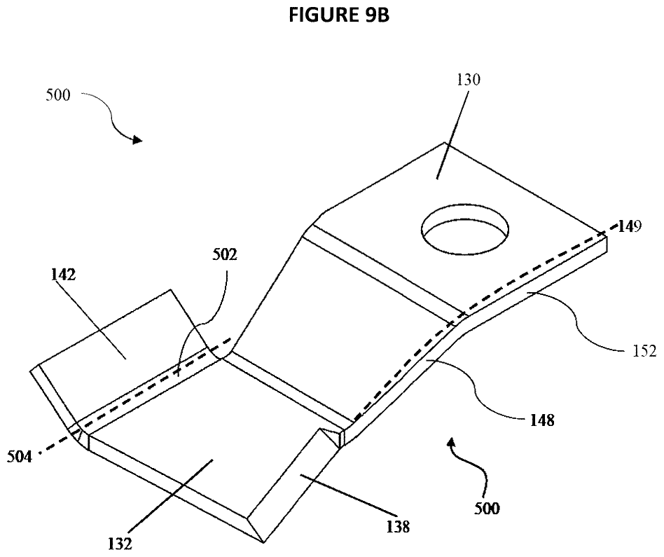

The cutting blade (400) has a cutting edge (138) which lies on a cutting edge axis indicated as (402) in FIGS. 9A and 9B. The cutting edge axis (402) is substantially parallel to, and preferably colinear with, an axis (404) which extends along the leading edge(s) (148 and/or 152). Accordingly, the cutting blade (400) has a rake angle of substantially zero.

### Further Alternate Embodiment of a Cutting Blade

Referring now to FIGS. 9A and 9B which show a further embodiment of a cutting blade (500) according to an aspect of the present invention. The cutting blade (500) has some similarities to the cutting blade (120A, 120B) and therefore like numerals are used to refer to like features.

The rear edge (502) lies on an axis indicated as 504 in FIGS. 9A and 9B. The axis (504) is substantially parallel to the axis (149) which extends along the leading edge(s) (148 and/or 152).

### Further Alternate Embodiment of a Cutting Blade

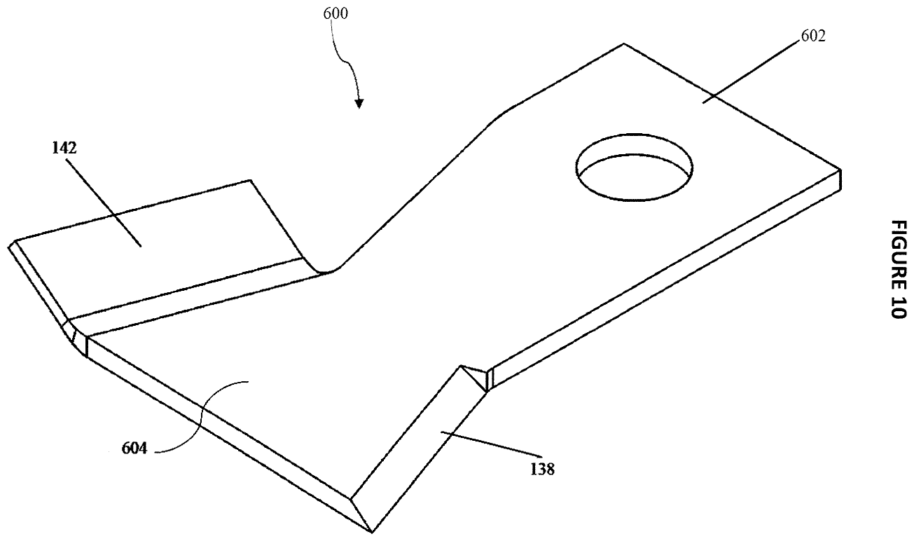

Referring now to FIG. 10 which shows a further embodiment of a cutting blade (600) according to an aspect of the present invention. The cutting blade (600) has some similarities to the cutting blade (120A, 120B) and therefore like numerals are used to refer to like features.

The cutting blade (600), in this embodiment does not include a step between a first portion (602) and a cutting portion (604) in which a cutting edge (606) is formed. Therefore, the first portion (602) and the cutting portion (604) lie in the same plane as each other.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

It will also be appreciated that various features of the embodiments described and illustrated herein may be combined to form yet further embodiments of the invention. These further forms of the invention are intended as being envisaged within the scope of the invention.

1-68. (canceled)

69. A cutting blade for use in a cutting assembly,
wherein the cutting blade includes:
a body, wherein the body includes a first portion having an attachment point which is configured to pivotably attach the cutting blade to a mounting beam,
a cutting portion having a cutting edge, and
a step that separates the first portion and the cutting portion from each other, and wherein the step is orientated at an angle to a substantially horizontal plane in which the first portion lies;
wherein the cutting edge is oriented at a rake angle which is the angle between a rake angle reference axis that extends along a leading edge of the cutting blade and a cutting edge axis that extends along at least a part of the cutting edge, and
further wherein the rake angle is in the range of substantially 4° to substantially 41°.

70. A cutting blade for a cutting assembly,
wherein the cutting blade includes:
a body, wherein the body includes
a first portion having an attachment point which is configured to pivotably attach the cutting blade to a mounting beam,
a cutting portion having a cutting edge, and
a step that separates the first portion and the cutting portion from each other, and wherein the step is orientated at an angle to a substantially horizontal plane in which the first portion lies;
wherein the cutting edge is oriented at a rake angle which is the angle between a rake angle reference axis and a cutting edge axis,
wherein the rake angle reference axis extends from a centre of rotation of the cutting blade in use to an outer tip of the cutting edge,
wherein the cutting edge axis extends along at least a part of the cutting edge,
and further wherein the rake angle is in the range of substantially 0° to substantially 30°.

71. The cutting blade of claim 70, wherein the cutting blade further comprises an upturn that has a forward-most edge and a rear edge, and further wherein the rear edge has an outer tip,
and wherein an upturn radius axis extends from the centre of rotation of the cutting blade in use to the outer tip.

72. The cutting blade of claim 71, wherein the outer tip is substantially 590 mm from the centre of rotation in use when secured to the mounting beam.

73. A cutting blade for a cutting assembly,
wherein the cutting blade includes:
a body, wherein the body includes
a first portion having an attachment point which is configured to pivotably attach the cutting blade to a mounting beam,
a cutting portion having a cutting edge, and
a step that separates the first portion and the cutting portion from each other, and wherein the step is orientated at an angle to a substantially horizontal plane in which the first portion lies;
wherein the cutting edge is oriented at a rake angle which is the angle between a rake angle reference axis and a cutting edge axis,
wherein the cutting edge axis extends along at least a part of the cutting edge, and
wherein the rake angle reference axis extends from a centre of rotation of the cutting blade in use to an intersection point,
the intersection point being the point of intersection between an axis that extends along the cutting edge and an axis that extends along a base edge of the cutting blade,
and further wherein the rake angle is in the range of substantially 0° to substantially 30°.

74. The cutting blade of claim 73, wherein cutting blade comprises an upturn that has a forward-most edge and a rear edge, and further wherein an upturn radius axis extends from the centre of rotation to a second intersection point, the second intersection point being the point of intersection between an axis that extends along the rear edge and an axis that extends along the base edge.

75. The cutting blade of claim 74, wherein the second intersection point is substantially 590 mm from the centre of rotation in use.

76. The cutting blade of claim 73, wherein the base edge provides an outermost edge of the body.

77. The cutting blade of claim 69, wherein at least a part of a/the leading edge of the cutting blade is substantially parallel to a rotation axis that extends from the attachment point to the centre of rotation.

78. The cutting blade of claim 69, wherein at least a part of a/the leading edge of the cutting blade is substantially non-parallel to a rotation axis that extends from the attachment point to the centre of rotation.

79. The cutting blade of claim 69, wherein the upturn and the cutting edge are located on opposite sides of the body of the cutting blade.

80. The cutting blade of claim 69, wherein the cutting edge is provided on a forward edge of the cutting blade.

81. A cutting assembly including:
the cutting blade according to claim 69, and
the mounting beam.

82. The cutting assembly of claim 81, wherein the mounting beam has a first end and a second end, and wherein the cutting blade is attached at or towards the first end of the mounting beam.

83. The cutting assembly of claim 82, further comprises a second cutting blade which is attached at or toward the second end of the mounting beam.
